(19) United States
(12) Patent Application Publication
(10) Pub. No.: US 2008/0174705 A1
(43) Pub. Date: Jul. 24, 2008

(54) LIQUID CRYSTAL DEVICE AND PROJECTOR INCLUDING THE SAME

(75) Inventors: Takashi ENDO, Shiojiri-shi (JP); Hiroaki YANAI, Shiojiri-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/970,877

(22) Filed: Jan. 8, 2008

(30) Foreign Application Priority Data
Jan. 22, 2007 (JP) 2007-011098

(51) Int. Cl. G02F 1/13363; G02F 1/1333

(52) U.S. Cl. 349/5; 349/119

(57) ABSTRACT

A liquid crystal device includes a liquid crystal cell containing liquid crystal operating in twisted nematic mode, a first compensating element disposed either on the light entrance side or on the light exit side of the liquid crystal cell and made of an optical material having positive uniaxial characteristics, a second compensating element disposed either on the light entrance side or on the light exit side of the liquid crystal cell and made of an optical material having positive uniaxial characteristics, a third compensating element disposed at least either on the light entrance side or on the light exit side of the liquid crystal cell and made of an optical material which satisfies the following condition for parameters Re and Rth concerning refractive index anisotropy: −Rth<Re<Rth, and a pair of polarizing elements between which the liquid crystal cell, the first compensating element, the second compensating element, and the third compensating element are disposed.

### BACKGROUND

1. Technical Field

The present invention relates to a liquid crystal device for image formation, and further to a projector including this liquid crystal device.

2. Related Art

A liquid crystal projector in related art has a twisted nematic type liquid crystal panel and two compensating optical elements disposed between the liquid crystal panel and a light entrance polarizing plate or a light exit polarizing plate. Each of the two compensating optical elements is constituted by a uniaxial element having an optic axis disposed in the rubbing direction and inclined at a predetermined angle to the entrance surface (see JP-A-2004-198650). According to this type of liquid crystal projector, pre-tilt of liquid crystal can be compensated by the adjustment of the optic axes or thicknesses of the compensating optical elements positioned in the vicinity of the liquid crystal panel for improvement over contrast.

When low-cost and easily processible crystal is used as the uniaxial optical anisotropy element discussed above, contrast improves in the direction around the front. However, in principle, compensation for light entering in an oblique direction is limited, and sufficient characteristics of viewing angle cannot be obtained.

### SUMMARY

Accordingly, it is an advantage of some aspects of the invention to provide a light modulating device, i.e., a liquid crystal device capable of easily acquiring preferable contrast and viewing angle characteristics.

It is another advantage of some aspect of the invention to provide a projector including this liquid crystal device.

A liquid crystal device according to an aspect of the invention includes a liquid crystal cell containing liquid crystal operating in twisted nematic mode, a first compensating element disposed either on the light entrance side or on the light exit side of the liquid crystal cell and made of an optical material having positive uniaxial characteristics, a second compensating element disposed either on the light entrance side or on the light exit side of the liquid crystal cell and made of an optical material having positive uniaxial characteristics, a third compensating element disposed at least either on the light entrance side or on the light exit side of the liquid crystal cell and made of an optical material which satisfies the following condition for parameters Re and Rth concerning refractive index anisotropy: −Rth<Re<Rth, and a pair of polarizing elements between which the liquid crystal cell, the first compensating element, the second compensating element, and the third compensating element are disposed. Assuming that refractive indexes in x, y, and z directions of the respective axes on the basis of the refractive index of the third compensating element are nx, ny, nz, and that the thickness of the third compensating element in the z direction is d3, the parameters Re and Rth are calculated by the following equations:

Re=(nx−ny)·d3 (1)

Rth={(nx+ny)/2−nz}·d3 (2)

Thus, the Re corresponds to the difference between the refractive indexes on a pair of the major axes side of refractive index ellipsoid, and the Rth corresponds to the difference between the refractive indexes on the major axis side and the minimum axis.

According to this liquid crystal device, the third compensating element is disposed at least on either the entrance side or on the exit side of the liquid crystal cell, and the parameters Re and Rth concerning the refractive index anisotropy satisfy the conditional expression −Rth<Re<Rth. Thus, optical compensation for obliquely incident light, which cannot be sufficiently attained by the first and second compensating elements having positive uniaxial characteristics, can be easily performed. More specifically, when optical compensation is performed for pre-tilt remaining on the liquid crystal cell only by using the first and second compensating elements, pseudo refractive index ellipsoid having the characteristics of a positive uniaxial extending in the normal line directions of the entrance surface and exit surface of the liquid crystal cell is produced. In this case, optical compensation for obliquely incident light can be more securely performed by compensating the positive uniaxial refractive index characteristics thus produced using the refractive index characteristics of the third compensating element. Therefore, image light retardation caused by the respective pre-tilts of the liquid crystal on the entrance surface side and exit surface side of the liquid crystal cell can be approximately cancelled or reduced in a wide range of viewing angle. Accordingly, enhanced contrast can be acquired.

When the optic axes of the liquid crystals positioned adjacent to the entrance surface and exit surface are disposed inclined to the normal line of the entrance surface under the OFF condition of the twisted nematic type liquid crystal cell (i.e., no voltage applied condition), so-called pre-tilts are produced on the liquid crystals. The pre-tilts of the liquid crystals in the vicinity of the entrance surface and exit surface are maintained substantially in the same condition even under the ON condition of the liquid crystal cell. According to this aspect of the invention, the average tilt condition remaining on the liquid crystals in the vicinity of the entrance surface and exit surface under the ON condition where a compensation target by the optical compensation element is liquid crystal on the ON condition is referred to as pre-tilt, and the average tilt condition remaining on the liquid crystals in the vicinity of the entrance surface and exit surface under the OFF condition where the compensation target is liquid crystal on the OFF condition is referred to as pre-tilt.

It is preferable that in the liquid crystal device, the third compensating element is disposed in such a position that the minimum axis of refractive index ellipsoid extends in the normal line directions of the entrance surface and exit surface of the liquid crystal cell in parallel with each other. In this case, positive uniaxial refractive index characteristics remaining after the optical compensation by the first and second compensating elements and extending in the normal line directions of the entrance surface and exit surface can be effectively compensated by the third compensating element. The first and second compensating elements are disposed such that the major axis of the refractive index ellipsoid is inclined at a certain angle to the normal line directions of the entrance surface and exit surface of the liquid crystal cell in accordance with the levels of the pre-tilts in the vicinity of the entrance surface and exit surface of the liquid crystal cell.

It is preferable that the third compensating element is either a sapphire plate or an extended film. In this case, the above conditional expression −Rth<Re<Rth can be securely satisfied, and therefore the optical compensation performed by the third compensating element can be securely achieved. When the third compensating element is formed by an extended film, the cost of the third compensating element can be relatively lowered.

It is preferable that the third compensating element contains a plurality of extended films. In this case, the optical compensation can be executed in cooperation among the plural extended films, and thus thermal distortion or other effect is not concentrated on a particular position. In addition, the third compensating element can be formed by a plurality of ready-made extended films.

It is preferable that the plural extended films are disposed in such positions that retardation produced within a plane in parallel with the entrance surface and exit surface of the liquid crystal cell can be cancelled. In this case, the third compensating element cancels asymmetry on the major axes side of the refractive index ellipsoid to further enhance the viewing angle characteristics.

It is preferable that the third compensating element is disposed away from at least either the liquid crystal cell or the pair of the polarizing elements. In this case, the third compensating element is disposed away from a heat generating source, and thus deterioration of optical characteristics caused by thermal distortion or the like is prevented.

It is preferable that each of the first and second compensating elements is a crystal plate. In this case, positive uniaxial refractive index characteristics can be easily acquired at low cost and with high accuracy.

It is preferable that each of the first and second compensating elements has a thickness sufficient for effectively canceling a component in cooperation with each other, which component exists within the plane in parallel with the entrance surface arid exit surface and is included in liquid crystal retardation caused by liquid crystal positioned in the vicinity of the entrance surface and exit surface in the liquid crystal cell. Also, the third compensating element has a thickness sufficient for effectively canceling a component existing in the direction perpendicular to the entrance surface and exit surface and included in the liquid crystal retardation and incidental retardation existing in the direction perpendicular to the entrance surface and exit surface and caused by the first and second compensating elements. In this case, retardation can be securely reduced in a wide range including not only the direction perpendicular to the exit surface of the liquid crystal cell but also around the direction perpendicular to the exit surface of the liquid crystal cell. Accordingly, image quality of an image formed by the liquid crystal device can be improved.

A projector according to another aspect of the invention includes the liquid crystal device that modulates light as described above, an illumination device which illuminates the liquid crystal device, and a projection lens which projects an image formed by the liquid crystal device.

According to this projector having the above liquid crystal device, such a phenomenon of conspicuous black and thus lowered image contrast in the display condition of the liquid crystal cell during the ON period can be prevented, for example. Accordingly, accuracy of light control, i.e., light modulation of the liquid crystal cell improves, and thus the projector provided according to this aspect of the invention can project a high-quality image by a simple structure.

### BRIEF DESCRIPTION OF THE DRAWINGS

The invention will be described with reference to the accompanying drawings, wherein like numbers refer to like elements.

FIG. 1 is a cross-sectional side view illustrating a structure of a liquid crystal light valve according to a first embodiment.

FIGS. 2A through 2D illustrate compensation for pre-tilt performed by first and second compensating elements.

FIG. 3 illustrates a concept of compensation effect obtained by using the first and second compensating elements.

FIG. 4A through 4C illustrate compensation for residual plural refractive indexes performed by a third compensating element.

FIG. 5 is a cross-sectional side view illustrating a liquid crystal light valve according to a second embodiment.

FIG. 6 is a cross-sectional side view illustrating a liquid crystal light valve according to a third embodiment.

FIG. 7 shows directions of optic axes of respective compensating element portions included in the third compensating element.

FIGS. 8A through 8C show characteristics obtained by simulations in an example, and FIG. 8D shows characteristics obtained in a comparison example.

FIGS. 9A through 9C are graphs showing the functions of the first compensating element, the second compensating element, and the third compensating elements.

FIG. 10 is a graph showing effect of the third compensating element varying according to the number of divisions.

FIG. 11 illustrates an optical system of a projector including the liquid crystal light valve shown in FIG. 1 and other figures.

### DESCRIPTION OF EXEMPLARY EMBODIMENTS

### First Embodiment

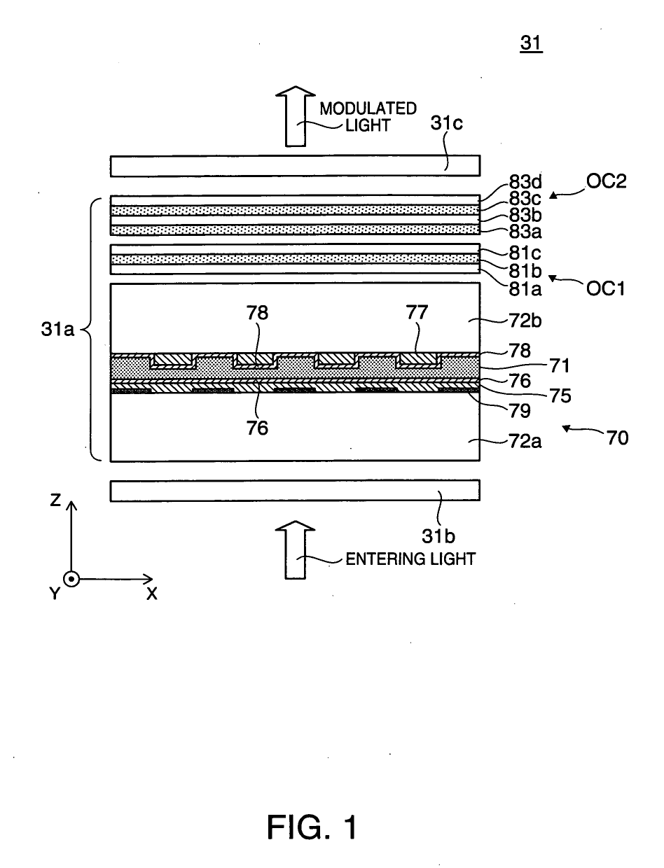

FIG. 1 is a cross-sectional view showing an enlarged structure of a liquid crystal light valve (light modulating device) as a liquid crystal device according to a first embodiment of the invention.

In a liquid crystal light valve 31 shown in the figure, a first polarizing filter 31b as a light entrance side polarizing element and a second polarizing filter 31c as a light exit side polarizing element constitute crossed nicols, for example. A polarization modulating unit 31a disposed between these first and second polarizing filters 31b and 31c is a liquid crystal panel which varies the polarization direction of entering light for each pixel in accordance with an input signal.

The polarization modulating unit 31a has a liquid crystal cell 70 which has a transparent first substrate 72a on the entrance side and a transparent second substrate 72b on the exit side with a liquid crystal layer 71 interposed therebetween. The liquid crystal layer 71 is constituted by liquid crystals operating in twisted nematic mode (that is, twisted nematic type liquid crystals). The polarization modulating unit 31a has a first optical compensating member OC1 and a second optical compensating member OC2 on the second polarizing filter 31c side of the liquid crystal cell 70. These substrates 72a and 72b and the optical compensating members OC1 and OC2 are disposed in such positions that the normal lines of the entrance and exit surfaces are disposed in parallel with a Z axis in a similar manner as the polarizing filters 31b and 31c.

In the liquid crystal cell 70, a transparent common electrode 75 is provided on the liquid crystal layer 71 side surface of the first substrate 72a. Furthermore, an orientation film 76 is provided on the common electrode 75, for example. On the other hand, a plurality of transparent pixel electrodes 77 disposed in matrix and thin film transistors (riot shown) electrically connected with the corresponding transparent pixel electrodes 77 are provided on the liquid crystal layer 71 side surface of the second substrate 72b. Furthermore, an orientation film 78 is provided on the pixel electrodes 77 and the thin film transistors, for example. The liquid crystal cell 70 basically has a structure containing the first and second substrates 72a and 72b, the liquid crystal layer 71 sandwiched between the first and second substrates 72a and 72b, and the electrodes 75 and 77, and functions as a light active element which varies the polarization condition of entering light according to an input signal. Each of the pixels constituting the liquid crystal cell 70 contains one of the pixel electrodes 77, the common electrode 75, and the liquid crystal layer 71 interposed between the pixel electrode 77 and the common electrode 75. A grid-shaped black matrix 79 is also provided between the first substrate 72a and the common electrode 75 to section the respective pixels.

The orientation films 76 and 78 are equipped to arrange liquid crystal compounds constituting the liquid crystal layer 71 in necessary directions. The one orientation film 76 disposes the liquid crystal compounds contacting the orientation film 76 in a first rubbing direction (such as X axis direction), and the other orientation film 78 disposes the liquid crystal compounds contacting the orientation film 78 in a second rubbing direction (such as Y axis direction). The orientation film 76 has a function of positioning the optic axes of the liquid crystal compounds in a direction containing an X-Z plane as a polarizing plane of the first polarizing filter 31b under OFF condition where no voltage is applied to the liquid crystal layer 71. In this condition, the orientation film 78 has a function of positioning the optic axes of the liquid crystal compounds in a direction containing a Y-Z plane as a polarizing plane of the second polarizing filter 31c. Thus, the optic axes of the liquid crystal compounds contained in the liquid crystal layer 71 are arranged in such a condition as to be gradually twisted from the first substrate 72a side to the second substrate 72b side. That is, the optic axis of the liquid crystal compound disposed inside the first substrate 72a, that is, at one end of the liquid crystal layer 71 adjacent to the orientation film 76 and the optic axis of the liquid crystal compound disposed inside the second substrate 72b, that is, at the other end of the liquid crystal layer 71 adjacent to the orientation film 78 form a twist angle of 90 degrees when projected on the X-Y plane. Therefore, the liquid crystal layer 71 sandwiched between the pair of the polarizing filters 31b and 31c is operated in normally white mode, and the maximum transmissive condition (light ON condition) is secured under the OFF condition where no voltage is applied. The optic axes of the liquid crystal compounds at both ends of the liquid crystal layer 71, that is, the areas in the vicinity of the orientation films 76 and 78 are not disposed in parallel with the X-Y plane, that is, the entrance surface and the exit surface opposed to the orientation films 76 and 78, but are inclined at a certain pre-tilt angle to these entrance surface and the exit surface. This structure will be described in more detail later.

On the other hand, the optic axes of the liquid crystal compounds disposed away from the orientation films 76 and 78 are positioned in parallel with the normal line of the first substrate 72a (specifically, Z direction) under the ON condition where voltage is applied to the liquid crystal layer 71, that is, under the light blocking condition (light OFF condition). However, the optic axes of the liquid crystal compounds at both ends of the liquid crystal layer 71, i.e., in the vicinity of the orientation films 76 and 78 are maintained substantially in the original condition. More specifically, the optic axes of the liquid crystal compounds at both ends disposed in the X direction and the Y direction along the polarizing surfaces of the first and second polarizing filers 31b and 31c are not disposed horizontal to the X-Y plane, i.e., the entrance surface or exit surface opposed to the orientation films 76 and 78 but kept inclined at a certain tilt angle or polar angle to the entrance surface and the exit surface. The optic axes of the liquid crystal compounds positioned in the vicinity of the orientation films 76 and 78 are slightly varied but almost maintained in the tilt condition inclined to the X-Y plane under both the OFF condition where no voltage is applied to the liquid crystal layer 71 and ON condition where voltage is applied to the liquid crystal layer 71. Thus, for optical compensation for the liquid crystal layer 71 under the ON condition, i.e., light blocking condition, the tilt angle corresponding to this tilt condition is also referred to as pre-tilt angle.

The first optical compensating member OC1 disposed on the exit side of the liquid crystal cell 70 has a glass plate 81a, a first compensating element 81b, and a glass plate 81c in this order from the entrance side. These glass plate 81a, first compensating element 81b, and glass plate 81c are flat plate elements each of which has the light entrance end surface and light exit end surface in parallel with each other, and are joined to one another by optical adhesive, for example. In this embodiment, the first compensating element 81b is a positive transparent uniaxial crystal, and is made of crystal plate or the like. The first compensating element 81b is disposed such that its optic axis is inclined at a certain angle to the Y-Z surface and also inclined at a predetermined tilt angle to the Z axis. That is, the optic axis of the first compensating element 81b is disposed in parallel with the X-Z surface, and inclined at the predetermined tilt angle to the Z axis, for example. In this structure, a thickness d1 of the first compensating element 81b is set at a value appropriate for achieving optical compensation which will be described later.

The second optical compensating member OC2 has a third compensating element 83a, a glass plate 83b, a second compensating element 83c, and a glass plate 83d in this order from the entrance side. These third compensating element 83a, glass plate 83b, second compensating element 83c, and glass plate 83d are flat plate elements each of which has the light entrance end surface and light exit end surface in parallel with each other, and are joined to one another by optical adhesive, for example. In this embodiment, the second compensating element 83c is a positive transparent uniaxial crystal, and is made of crystal plate or the like. The second compensating element 83c is disposed such that its optic axis is inclined at a certain angle to the X-Z surface and also inclined at a predetermined tilt angle to the Z axis. That is, the optic axis of the second compensating element 83c is disposed in parallel with the Y-Z surface, and inclined at the predetermined tilt angle to the Z axis, for example. The third compensating element 83a is a negative transparent uniaxial substance, and made of sapphire or the like. The third compensating element 83a is disposed such that its optic axis extends in parallel with the Z axis. In this structure, a thickness d2 of the second compensating element 83c and a thickness d3 of the third compensating element 83a are set at values appropriate for achieving optical compensation which will be described later.

Assuming that refractive indexes in x, y, and z directions of the respective axes on the basis of the refractive index of the third compensating element 83a are nx, ny, nz, and that the thickness of the third compensating element 83a in the z direction is d3, parameters Re and Rth concerning refractive index anisotropy of the third compensating element 83a are calculated by the following equations:

$$\begin{matrix}Re = ( nx - ny ) \cdot d 3 = 0 & ( 3 ) \\ \begin{matrix}Rth = \{ ( nx + ny ) / 2 - nz \} \cdot d 3 \\ = \{ nx - nz \} \cdot d 3\end{matrix} & ( 4 )\end{matrix}$$

Thus, the following conditional expression (5) is satisfied:

−Rth<Re<Rth (5)

The first and second optical compensating members OC1 and OC2 discussed above have a function of compensating the viewing angle dependence and lowered contrast caused by the pre-tilt of the liquid crystal layer 71 in cooperation with each other.

More specifically, the first compensating element 81b and the second compensating element 83c effectively cancels the component in the X-Y plane contained in liquid crystal retardation caused by the pre-tilt of the liquid crystals positioned at both ends of the liquid crystal layer 71. Thus, the azimuth angle and polar angle of the optic axes of the first and second compensating elements 81b and 83c, and the thicknesses d1 and d2 of the first and second compensating elements 81b and 83c are adjusted at the time of manufacture.

In addition, the third compensating element 83a has a function of effectively canceling the component perpendicular to the entrance surface and exist surface contained in the liquid crystal retardation caused by the pre-tilt of the liquid crystals positioned at both ends of the liquid crystal layer 71, and incidental retardation in the Z direction caused by the first and second compensating elements 81b and 83c. Thus, the direction of the optic axis and the thickness d3 of the third compensating element 83a are adjusted.

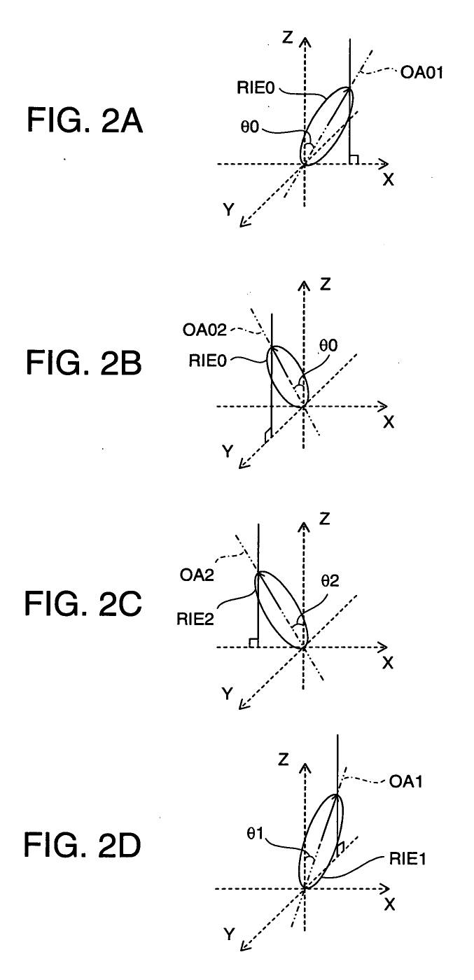

FIGS. 2A through 2D are perspective views showing the concept of compensation for the pre-tilt (that is, compensation for liquid crystal retardation) by using the first compensating element 81b and the second compensating element 83c.

As illustrated in FIG. 2A, the average pre-tilt on the entrance side of the liquid crystal layer 71 can be considered as a condition substantially in parallel with the X-Z surface and inclined at an angle of θ0 to the Z axis, for example. That is, a refractive index ellipsoid RIE0 having this pre-tilt has an optic axis OA01 inclined at a polar angle of θ0 to the Z axis and disposed substantially in the +X direction. In the area near the entrance surface of the liquid crystal layer 71, particularly the optic axis of the liquid crystal compound extremely close to the entrance surface has the same angle as the pre-tilt angle before voltage is applied, and the angle formed by the entrance surface and this optic axis is generally smaller than 10°. The angle of the optic axis of the liquid crystal compound rapidly approaches an angle in parallel with the normal line direction of the entrance surface, i.e., the Z direction as the position of the liquid crystal compound shifts toward the center of the liquid crystal layer during the voltage-applied period.

As illustrated in FIG. 2B, the average pre-tilt on the exit side of the liquid crystal layer 71 can be considered as a condition substantially in parallel with the Y-Z surface and inclined at the angle of θ0 to the Z axis, for example. That is, the refractive index ellipsoid RIE0 having the pre-tilt has an optic axis OA02 inclined at the polar angle of θ0 to the Z axis and disposed substantially in the +Y direction. In the area near the exit surface of the liquid crystal layer 71, particularly the optic axis of the liquid crystal compound extremely close to the exit surface has the same angle as the pre-tilt angle before voltage is applied, and the angle formed by the entrance surface and this optic axis is generally smaller than 10°. The angle of the optic axis of the liquid crystal compound rapidly approaches an angle in parallel with the normal line direction of the exit surface, i.e., the Z direction as the position of the liquid crystal compound shifts toward the center of the liquid crystal layer during the voltage-applied period.

As illustrated in FIG. 2C, the optic axis OA2 of the refractive index ellipsoid RIE2 of the first compensating element 81b lies in the condition substantially in parallel with the X-Z surface and inclined at an angle of θ2 to the Z axis. As illustrated in FIG. 2D, the optic axis OA1 of the refractive index ellipsoid RIE1 of the second compensating element 83c lies in the condition substantially in parallel with the Y-Z surface and inclined at an angle of θ1 to the Z axis.

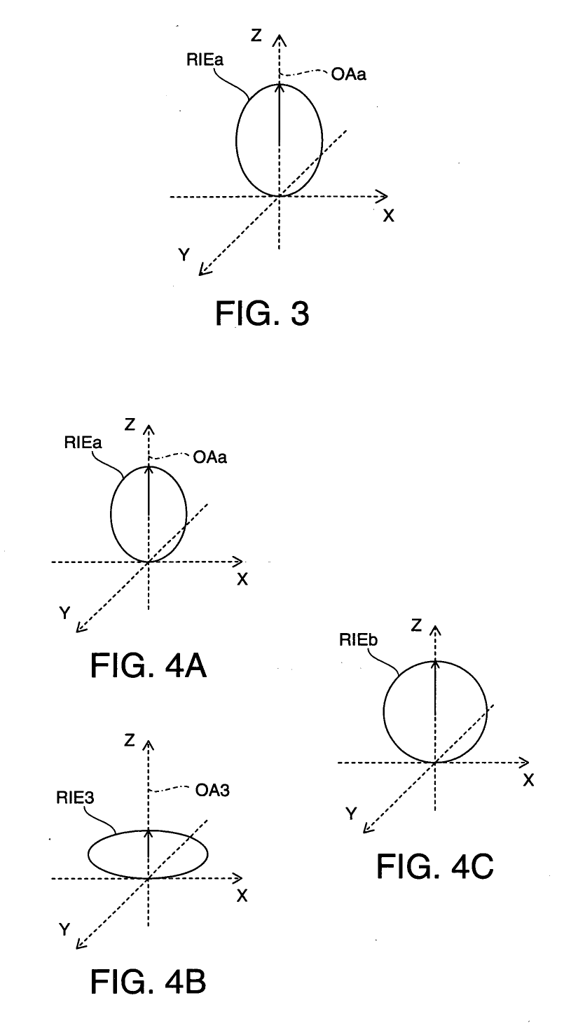

FIG. 3 illustrates the concept of the effect obtained by the compensation performed using the first and second compensation elements 81b and 83c. A refractive index ellipsoid RIEa produced by combining the pre-tilts of the liquid crystal layer 71 near its entrance surface and exit surface and the refractive index anisotropies of the first and second compensation elements 81b and 83c has positive uniaxial refractive index characteristics where an optic axis OAa of the ellipsoid RIEa corresponds to the major axis extending in parallel with the Z axis. This refractive index ellipsoid RIEa can be considered as vertical residual plural refractions obtained by adding the Z-directional component in the liquid crystal retardation caused by the pre-tilt of the liquid crystal layer 71 and the incidental retardation in the Z direction caused by the refractive index ellipsoids RIE1 and RIE2 of the first and second compensation elements 81b and 83c.

FIGS. 4A through 4C illustrate the compensation for the residual plural refractive indexes discussed above performed by the third compensation element 83a. FIG. 4A corresponds to FIG. 3, showing the refractive index ellipsoid RIEa remaining after compensation for the pre-tilt of the liquid crystal layer 71 by using the first and second compensation elements 81b and 83c, and FIG. 4B shows a refractive index ellipsoid RIE3 of the third compensation element 83a. This refractive index ellipsoid RIE3 has negative uniaxial characteristics where an optic axis OA3 corresponds to the minor axis extending in parallel with the Z axis. Based on the fact that the refractive index ellipsoid RIEa has positive uniaxial characteristics and that the refractive index ellipsoid RIE3 has negative uniaxial characteristics, apparent refractive index anisotropy can be cancelled by combining both. In this case, as illustrated in FIG. 4C, a refractive index ellipsoid RIEb after compensation for the pre-tilt of the liquid crystal layer 71 performed by using the first, second and third compensating elements 81b, 83c and 83a becomes a substantially circular shape. Thus, variations in retardation can be reduced not only for light coming from the front in parallel with the Z axis but also light coming in a direction inclined at a certain angle to the front direction, and therefore preferable light modulation characteristics can be obtained in a wide range of viewing angle.

As obvious from above explanation, the third compensation element 83a contained in the liquid crystal light valve 31 according to this embodiment has negative uniaxial refractive index anisotropy. Thus, optical compensation for obliquely incident light, which cannot be sufficiently attained by the first and second compensating elements 81b and 83c having positive uniaxial characteristics, can be easily performed. Therefore, image light retardation caused by the respective pre-tilts produced on the entrance surface side and exit surface side of the liquid crystal layer 71 can be approximately cancelled or reduced in a wide range of viewing angle. Accordingly, enhanced contrast can be acquired, and also images with reduced color non-uniformity can be projected as a result of the compensation for viewing angle.

### Second Embodiment

A liquid crystal light valve as a liquid crystal device according to a second embodiment of the invention is now described. The liquid crystal light valve in the second embodiment is a modification of the liquid crystal light valve in the first embodiment, and the components not specifically touched upon are similar to those in the first embodiment and not repeatedly explained.

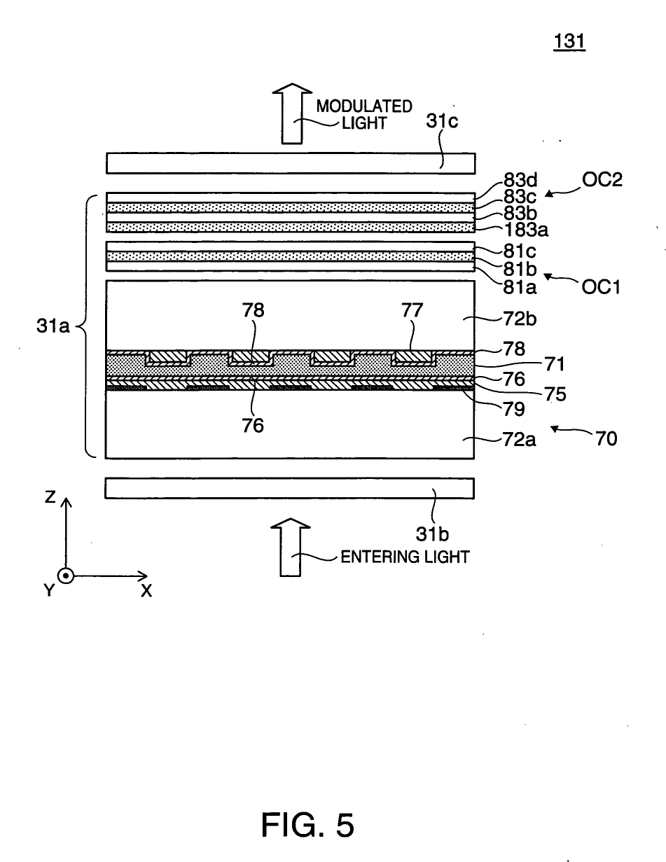

FIG. 5 is a cross-sectional view of an enlarged structure of the liquid crystal light valve in the second embodiment. In a liquid crystal light valve 131 shown in the figure, a third compensating element 183a constituting the second optical compensating member OC2 of the polarization modulating unit 31a is not formed by negative uniaxial crystal such as sapphire but by extended film having refractive index anisotropy similar to negative uniaxial characteristics such as TAC (triacetyl cellulose). This extended film exhibits relatively easily adjustable retardation and therefore is appropriate for mass production.

Assuming that refractive indexes in x, y, and z directions of the respective axes on the basis of the refractive index of the third compensating element 183a are nx, ny, nz, and that the thickness of the third compensating element 183a in the z direction is d3, parameters Re and Rth concerning refractive index anisotropy of the third compensating element 183a are calculated by the following equations:

Re=(nx−ny)·d3 (1)

Rth={(nx+ny)/2−nz}·d3 (2)

Thus, the following conditional expression (5) is satisfied:

−Rth<Re<Rth (5)

Thus, the difference Re between a pair of the refractive indexes on the major axes side (nx and ny) is made smaller than the difference Rth between the refractive indexes on the major axis side (nx and ny) and the minimum axis (nz) in the refractive index ellipsoid of the third compensating element 183a by controlling the setting in the manufacture method of the extended film constituting the third compensating element 183a. In this case, the value Rth is a positive value. The z direction of the third compensating element 183a corresponds to the Z direction in parallel with the normal lines of the entrance and exit surfaces of the third compensating element 183a.

According to the liquid crystal light valve 131 in this embodiment, the third compensating element 183a has refractive index anisotropy similar to negative uniaxial characteristics as discussed above. Thus, optical compensation for obliquely incident light, which cannot be sufficiently attained by the first and second compensating elements 81b and 83c having positive uniaxial characteristics, can be easily performed. Therefore, image light retardation caused by the respective pre-tilts produced on the entrance surface side and exit surface side of the liquid crystal layer 71 can be approximately cancelled or reduced in a wide range of viewing angle. Accordingly, enhanced contrast can be acquired, and also images with reduced color non-uniformity can be projected as a result of the compensation for viewing angle.

### Third Embodiment

A liquid crystal light valve as a liquid crystal device according to a third embodiment of the invention is now described. The liquid crystal light valve in the third embodiment is a modification of the liquid crystal light valve in the second embodiment, and the components not specifically touched upon are similar to those in the second embodiment.

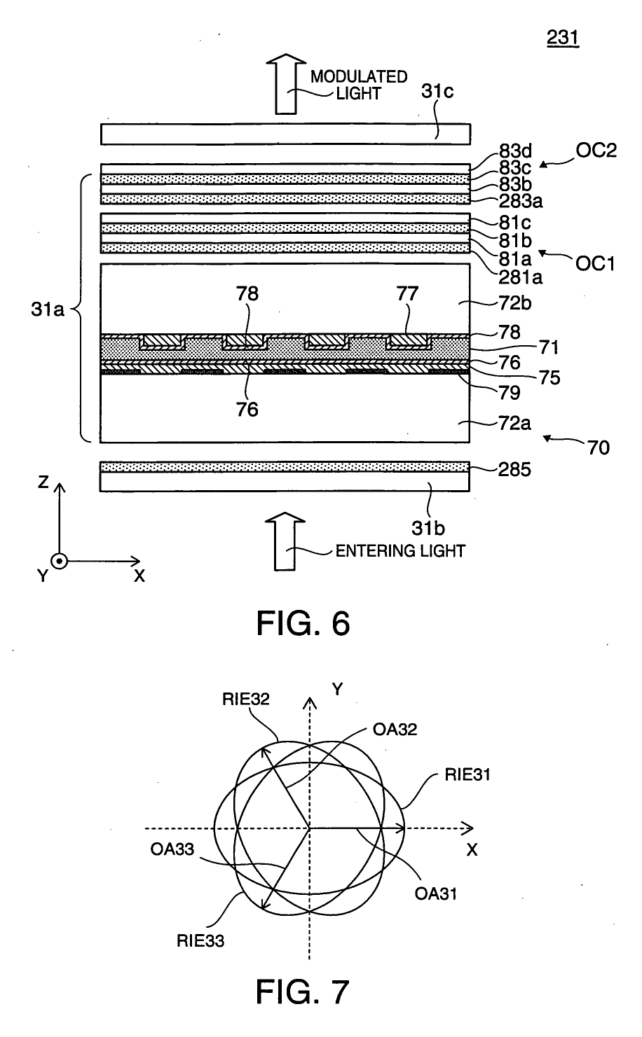

FIG. 6 is a cross-sectional view illustrating an enlarged structure of the liquid crystal light valve in the third embodiment. In a liquid crystal light valve 231 shown in the figure, a compensating element portion 281a formed by an extended film having refractive index anisotropy similar to negative uniaxial characteristics such as TAC is included in the first optical compensating member 0C1 of the polarization modulating unit 31a. Similarly, a compensating element portion 283a formed by an extended film having refractive index anisotropy similar to negative uniaxial characteristics such as TAC is included in the second optical compensating member OC2 of the polarization modulating unit 31a. These compensating element portions 283a and 281a are separately disposed, but both constitute the third compensating element.

The refractive index anisotropy similar to negative uniaxial characteristics refers to such characteristics that the refractive index difference Re and refractive index difference Rth satisfy the expressions (1), (2) and (5) similarly to those of the third compensating element 183a in the second embodiment, and that the values of nx and ny are slightly different from each other.

When an element 285 as a member for supporting the inside polarizing element of the first polarizing filter 31b in the entrance side has refractive index anisotropy similar to negative uniaxial characteristics as illustrated in FIG. 6, the element 285 (compensating element portion 285) as well as the compensating element portions 283a and 281a can constitute the third compensating element.

FIG. 7 illustrates the direction of the maximum axes of the respective compensating element portions 281a, 283a and 285. When each of the three elements has the equal retardation Re, a maximum axis OA31 of a refractive index ellipsoid RIE31 of the compensating element portion 285 provided inside the first polarizing filter 31b extends in parallel with the X axis. A maximum axis OA32 of a refractive index ellipsoid RIE32 of the compensating element portion 281a provided on the first optical compensating member OC1 extends in the direction inclined at 120° to the X axis. A maximum axis OA33 of a refractive index ellipsoid RIE33 of the compensating element portion 283a provided on the second optical compensating member OC2 extends in the direction inclined at 240° to the X axis. Thus, an equal angle of 120° is formed between each adjoining pair of the optic axes of the compensating element portions 283a, 281a and 285.

In this case, each of the compensating element portions 281a, 283a and 285 allocates the longer axis of the refractive index ellipsoid on the major axis side (x axis when nx>ny) to the equally angled direction in the X-Y plane while maintaining the minimum axis z of the refractive index ellipsoid in the Z direction in parallel with the normal lines of the entrance and exit surfaces of the liquid crystal layer 71. Thus, the refractive index anisotropies, i.e., the retardations of the respective compensating element portions 281a, 283a and 285 in the X-Y plane can be mutually cancelled. As a result, compensation thus achieved looks as if accurate negative uniaxial crystals are produced on the whole.

It is preferable that the element 285 having phase is eliminated when heat generation from the first polarizing filter 31b is large. In this case, the third compensating element is constituted only by the compensating element portions 283a and 281a as in the above example.

According to this embodiment, the third compensating element has three divisional sections of the compensating element portions 281a, 283a and 285. However, the third compensating element may be constituted by two divisional parts, or four, five, six, seven, or a larger number of parts. By disposing the optic axes of these compensating element portions at equal intervals around the Z axis, the refractive index ellipsoid RIEa (see FIG. 3) remaining after compensation for the pre-tilt of the liquid crystal layer 71 performed by using the first and second compensating elements 81b and 83c can be compensated with high accuracy.

### EXAMPLE

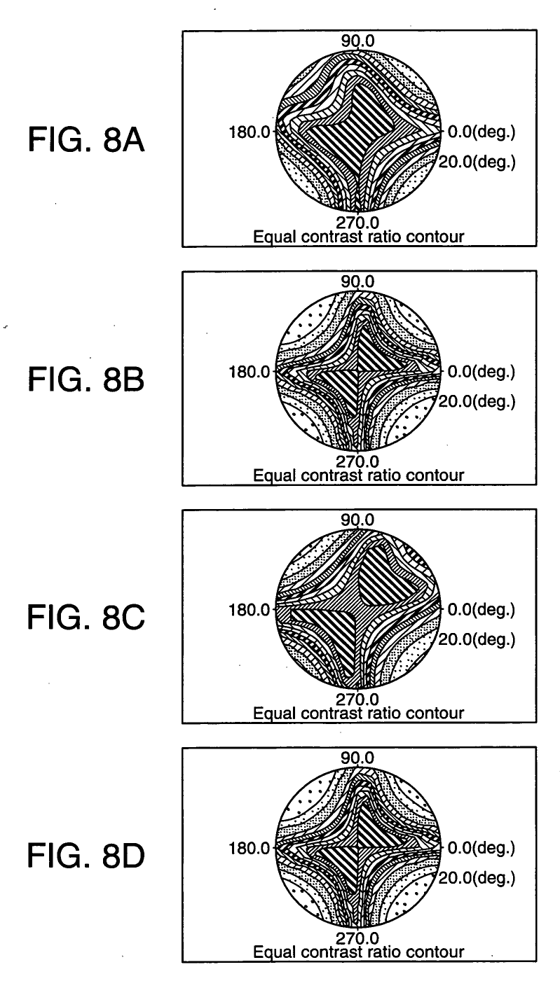

A specific example is now described. FIG. 8A shows a simulation result obtained by giving specific numerical values to the liquid crystal light valve 31 according to the first embodiment. FIGS. 8B and 8C show simulation results obtained by giving specific numerical values to the liquid crystal light valve 231 according to the third embodiment. FIG. 8D shows a simulation result obtained from a liquid crystal light valve in a comparison example not having the third compensating element. Except for the third compensating element, components having common specifications are used in the simulations. In case of the liquid crystal light valve 31 shown in FIG. 8A, the third compensating element 83a is formed by a sapphire crystal plate, the entrance and exit surfaces corresponds to the C surface extending in the normal line direction of the optic axis, and the thickness of the third compensating element 83a is 47 μm. In case of the liquid crystal light valve 231 shown in FIG. 8B, the third compensating element has the three compensating element portions 281a, 283a and 285, each of which is made of TAC having Re of 4 nm, Rth of 80 nm, and thickness d3 of 80 μm. In case of the liquid crystal light valve 231 shown in FIG. 8C, the third compensating element has seven compensating element portions, each of which is made of TAC having Re of 4 nm, Rth of 80 nm, and thickness d3 of 80 μm. Under these conditions, the contrast values of the liquid crystal light valves in the example are 4,200, 3,700, and 4,200 in the order of the light valves in FIGS. 8A, 8B and 8C. The contrast value of the liquid crystal light valve in the comparison example shown in FIG. 8D is 3,100. As apparent from these results, the contrast characteristics of the liquid crystal light valve are enhanced by using sapphire crystal plate or TAC for the third compensating element, and a wide area having high contrast is obtained. Accordingly, the viewing angle characteristics improve with increase in high-contrast areas, offering preferable contrast even for light entering in an oblique direction.

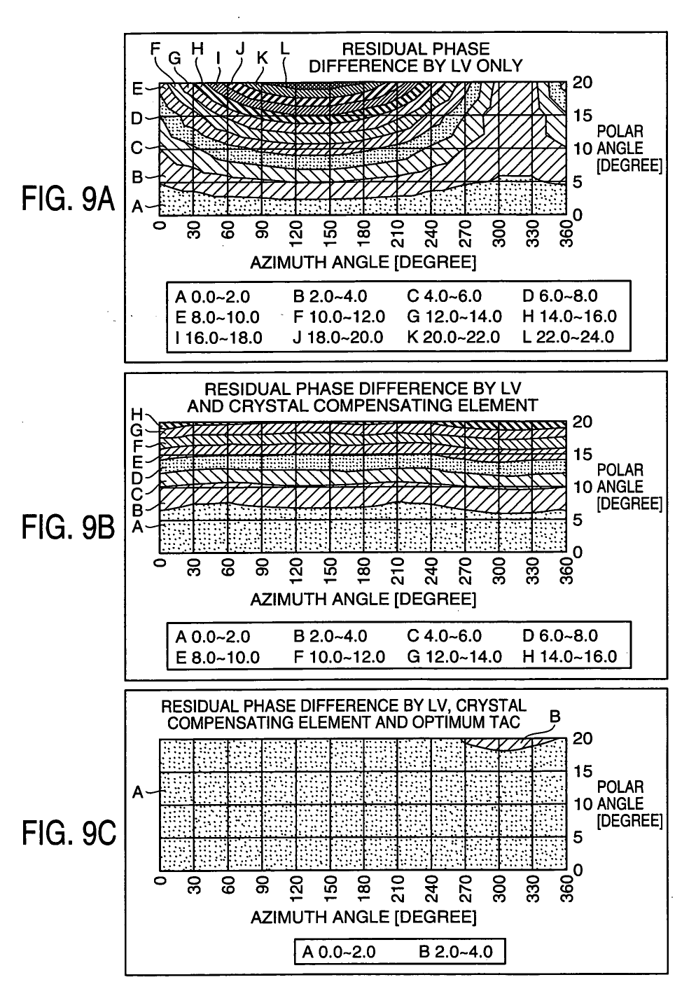

FIGS. 9A through 9C are graphs showing the functions of the first compensating element 81b, the second compensating element 83c, and the third compensating elements 281a, 283a and 285. FIG. 9A shows residual retardation of a liquid crystal light valve having no compensating element in a comparison example. FIG. 9B shows residual retardation of the liquid crystal light valve having two crystal plates as the first and second compensating elements 81b and 83c in a comparison example. FIG. 9C shows residual retardation of the liquid crystal light valve having the third compensating element including seven TAC components as well as the first and second compensating elements 81b and 83c in the example. In these graphs, the horizontal axis indicates azimuth angle of light entering the liquid crystal light valve, and the vertical axis indicates polar angle of light entering the liquid crystal light valve.

As obvious from the comparison between FIGS. 9A and 9B, the pre-tilt is compensated to some extent and the residual retardation is reduced when the first and second compensating elements 81b and 83c are used. The residual retardation varies only depending on the polar angle with small dependence on the azimuth angle. This shows the fact that the residual retardation after compensation by the first and second compensating elements 81b and 83c corresponds to positive uniaxial refractive index ellipsoid, and that the major axis of the ellipsoid extends in the Z direction (see FIG. 3). As apparent from the comparison between FIGS. 9B and 9C, the residual retardation depending on the polar angle is reduced when the third compensating element is used as well as the first and second compensating elements 81b and 83c. More specifically, substantially isotropic pseudo refractive index is produced after compensation by the first through third compensating elements (see FIG. 4C), and the viewing angle dependency improves with enhanced contrast.

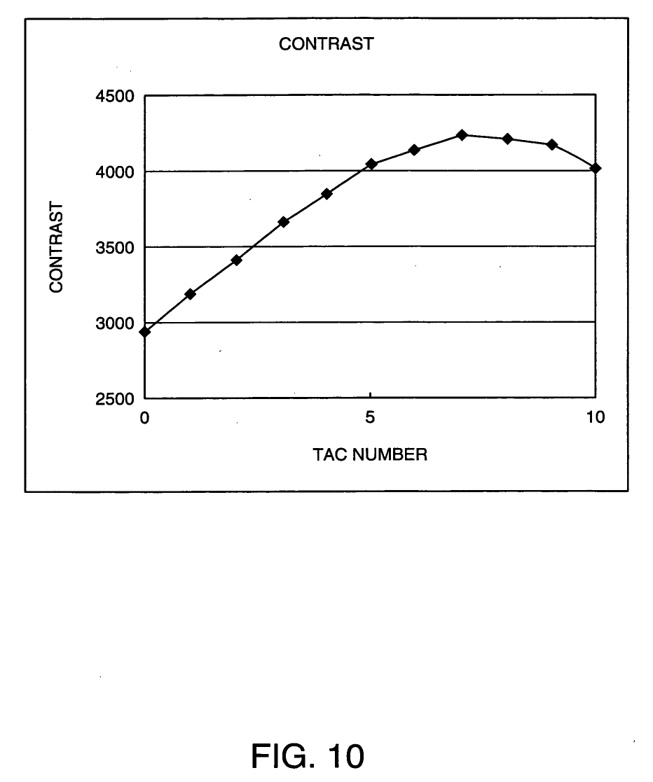

FIG. 10 is a graph showing the effect obtained by a structure which contains the third compensating element formed by laminating TAC layers each of which has Re of 4 nm, Rth of 80 nm, and thickness of 80 μm. In case of an example shown in FIG. 8B, the third compensating element has three TAC layers. In case of an example shown, in FIG. 8C, the third compensating element has seven TAC layers. In the structure which laminates the films having retardation, contrast increases as compensation approaches the optimum number, and contrast decreases after the number of the films exceeds the optimum number, i.e., seven in this example, due to excessive compensation.

### Fourth Embodiment

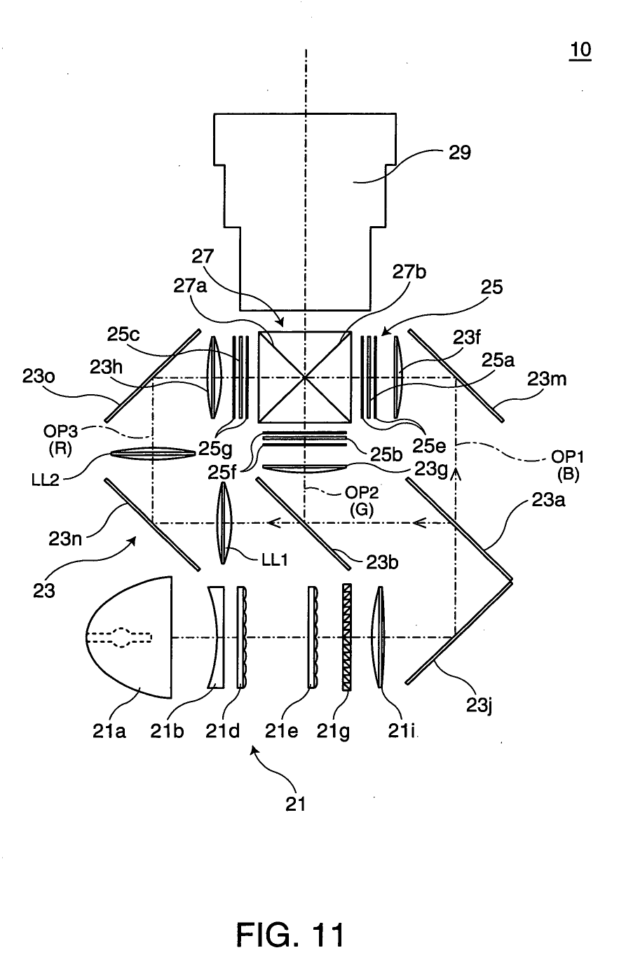

FIG. 11 illustrates a structure of an optical system of a projector including the liquid crystal light valve 31 and other components shown in FIG. 1.

A projector 10 in this embodiment includes a light source device 21 for emitting source light, a color division optical system 23 for dividing the source light emitted from the light source device 21 into three color lights in red, green and blue, a light modulating unit 25 illuminated by the illumination light in respective colors released from the color division optical system 23, a cross dichroic prism 27 for synthesizing lights in respective colors released from the light modulating unit 25 into image light, and a projection lens 29 as a projection optical system for projecting image light having passed, through the cross dichroic prism 27 onto a screen (not shown). In these components, the light source device 21, the color division optical system 23, the light modulating unit 25, and the cross dichroic prism 27 constitute an image forming device for forming an image light to be projected on the screen.

In the projector 10 having the above structure, the light source device 21 has a light source lamp 21a, a concave lens 21b, a pair of lens arrays 21d and 21e, a polarization converting member 21g, and a superposing lens 21i. The light source lamp 21a is a high-pressure mercury lamp, for example, and has a concave mirror which collects source light and releases the light toward the front. The concave lens 21b has a function of collimating the source light emitted from the light source lamp 21a, but can be eliminated. The pair of the lens arrays 21d and 21e are constituted by a plurality of element lenses disposed in matrix. These element lenses divide the source light having been emitted from the light source lamp 21a and passed through the concave lens 21b into partial lights and converge and diverge the respective partial lights. The polarization converting member 21g converts the source lights released from the lens array 21e into only S-polarized light components extending perpendicular to the sheet surface of FIG. 11, for example, and supplies the converted light components to the subsequent optical system. The superposing lens 21i appropriately converges the overall illumination lights having passed through the polarization converting member 21g so that the illumination lights can be superposed and applied onto modulating devices for respective colors included in the light modulating unit 25. More specifically, the illumination lights having passed through both the lens arrays 21d and 21e and the superposing lens 21i pass through the color division optical system 23 which will be described later, and are uniformly superposed and applied onto liquid crystal panels 25a, 25b and 25c for respective colors included in the light modulating unit 25.

The color division optical system 23 has first and second dichroic mirrors 23a and 23b, three field lenses 23f, 23g and 23h as a correction optical system, and reflection mirrors 23j, 23m, 23n and 23o, and constitutes the illumination device together with the light source device 21. The first dichroic mirror 23a reflects red light and green light in the three lights in red, green and blue and transmits blue light, for example. The second dichroic mirror 23b reflects green light in the two entering color lights in red and green and transmits red light, for example. In the color division optical system 23, the optical path of the source light substantially in white emitted from the light source device 21 is bended by the reflection mirror 23j, and enters the first dichroic mirror 23a. The blue light, having passed through the first dichroic mirror 23a passes the reflection mirror 23m and enters the field lens 23f as S-polarized light without change, for example. The green light reflected by the first dichroic mirror 23a and further by the second dichroic mirror 23b enters the field lens 23g as S-polarized light without change, for example. The red light having passed through the second dichroic mirror 23b passes through lenses LL1 and LL2 and the reflection mirrors 23n and 23o, and enters the field lens 23h for adjusting the incident angle as S-polarized light without change, for example. The lenses LL1 and LL2 and the field lens 23h constitute a relay optical system. This relay optical system has a function of transmitting the image at the first lens LL1 to the field lens 23h via the second lens LL2 substantially without change.

The light modulating unit 25 has the three liquid crystal panels 25a, 25b and 25c, and three pairs of polarizing filters 25e, 25f and 25g between each pair of which the corresponding one of the liquid crystal panels 25a, 25b and 25c is sandwiched. In these components, the liquid crystal panel 25a for blue light and the pair of the polarizing filters 25e, 25e between which the liquid crystal panel 25a is interposed constitute a liquid crystal light valve for blue light which two-dimensionally modulates the luminance of blue light in image lights after luminance modulation based on image information. The liquid crystal light valve for blue light has a structure similar to that of the liquid crystal light valves 31, 131 and 231 shown in FIG. 1 or other figures, and contains the first and second optical compensating members OC1 and OC2 and the third compensating elements 83a, 183a, 281a, 283a, 285, and other components used for improving contrast. Similarly, the liquid crystal panel 25b for green light and the corresponding polarizing filters 25f, 25f constitute a liquid crystal light valve for green light, and the liquid crystal panel 25c for red light and the corresponding polarizing filters 25g, 25g constitute a liquid crystal light valve for red light. These liquid crystal light valves for green light and red light also have structures similar to those of the liquid crystal light valves 31, 131 and 231 shown in FIG. 1 or other figures.

The blue light separated after passing through the first dichroic mirror 23a of the color division optical system 23 enters the first liquid crystal panel 25a for blue light via the field lens 23f. The green light separated after reflected by the second dichroic mirror 23b of the color division optical system 23 enters the second liquid crystal panel 25b for green light via the field lens 23g. The red light separated after passing through the second dichroic mirror 23b enters the third liquid crystal panel 25c for red light via the field lens 23h. The respective liquid crystal panels 25a through 25c are non-emission-type light modulating devices which modulate spatial intensity distribution of entering illumination light per pixel. The three color lights entering the corresponding liquid crystal panels 25a through 25c are modulated according to a driving signal or image signal as an electric signal inputted to the respective liquid crystal panels 25a through 25c. In this step, the polarizing filters 25e, 25f and 25g adjust the polarization directions of the illumination lights entering the respective liquid crystal panels 25a through 25c, and extract component lights having predetermined polarization directions as image lights from the modulated lights released from the respective liquid crystal panels 25a through 25c.

The cross dichroic prism 27 is a light synthesizing member. The cross dichroic prism 27 has a substantially square shape in the plan view formed by affixing four rectangular prisms. A pair of dielectric multi-layer films 27a and 27b crossing each other in an X shape are provided on the boundary surfaces of the attached rectangular prisms. The first dielectric multi-layer film 27a reflects blue light, and the other second dielectric multi-layer film 27b reflects red light. The cross dichroic prism 27 reflects blue light released from the liquid crystal panel 25a by the first dielectric multi-layer film 27a and releases the blue light to the right with respect to the light traveling direction. The cross dichroic prism 27 directs green light released from the liquid crystal panel 25b such that the green light advances straight and is released by using the first and second dielectric multi-layer films 27a and 27b. The cross dichroic prism 27 reflects red light released from the liquid crystal panel 25c by the second dielectric multi-layer film 27b and releases the red light to the left with respect to the light traveling direction.

The projection lens 29 projects color image light produced after synthesis of the cross dichroic prism 27 onto the screen (not shown) with desired magnification. More specifically, a color dynamic image or color still image with desired magnification in accordance with a driving signal or image signal inputted to the respective liquid crystal panels 25a through 25c is projected on the screen.

The invention is not limited to the embodiments described and depicted herein, but various changes and modifications may be made without departing from the scope of the invention. For example, the following modifications are possible.

While crystal plates are used as the first and

second compensating elements 81b and 83c in these embodiments, positive uniaxial crystals or organic substances (such as liquid crystals or extended films) may be used in place of the crystal plates.

While the third compensating element is formed by sapphire or TAC in the embodiments, it may be constituted by negative uniaxial materials or materials having refractive index anisotropy similar to negative uniaxial characteristics instead of sapphire and TAC. More specifically, inorganic materials such as calcite, KDP (potassium dihydrogen phosphate), ADP (ammonium dihydrogen phosphate), and others may be used. Also, various types of olefin organic materials may be used. Alternatively, when the third compensating element is constituted by a plurality of layers as compensating portions, the third compensating element may be formed by combining and laminating a plurality of types of material layers.

While the first and second optical compensating members OC1 and OC2 are disposed between the liquid crystal cell 70 and the second polarizing filter 31c in the embodiments, the optical compensating members OC1 and OC2 may be positioned between the liquid crystal cell 70 and the first polarizing filter 31b. In addition, the first and second optical compensating members OC1 and OC2 may be separately located on the entrance side and exit side of the liquid crystal cell 70.

While the contrast is improved by compensating the retardation under the ON condition where voltage is applied to the liquid crystal layer 71, that is, the light OFF condition in the embodiments, the retardation may be compensated under the OFF condition where no voltage is applied to the liquid crystal layer 71, that is, the light ON condition.

In the liquid crystal cell 70 according to the embodiments, a micro-lens array constituted by small lenses may be embedded in the first substrate 72a or the like in correspondence with pixels. However, it is preferable that the first and second optical compensating members OC1 and OC2 and other compensating elements are positioned after the liquid crystal cell 70 so that the expanding angle or the like of light passing through the liquid crystal cell 70 coincides with the expanding angle or the like of light passing through the first and second optical compensating members OC1 and OC2.

While the light source device 21 of the projector 10 according to the embodiment has the light source lamp 21a, the pair of the lens arrays 21d and 21e, the polarization converting member 21g, and the superposing lens 21i, the lens arrays 21d and 21e, the polarization converting member 21g and the like may be eliminated. Moreover, the light source lamp 21a may be replaced with other types of light source such as LED.

According to the embodiments, the illumination light is divided into lights in respective colors by the color division optical system 23. Then, the respective color lights are modulated by the light modulating unit 25, and the modulated lights are synthesized into an image in respective colors by the cross dichroic prism 27. However, images may be formed by using a single liquid crystal panel as the single liquid crystal light valve 31.

While only the example of the projector 10 using the three liquid crystal panels 25a through 25c has been discussed in the embodiment, the invention is applicable to a projector using a single liquid crystal panel, a projector using two liquid crystal panels, or a projector using four or more liquid crystal panels.

While only the example of the front-type projector which projects images from the screen observing side has been discussed in the embodiment, the invention is applicable to a rear-type projector which projects images from the side opposite to the screen observing side.

The entire disclosure of Japanese Patent Application No. 2007-011098, filed Jan. 22, 2007 is expressly incorporated by reference herein.

What is claimed is:

1. A liquid crystal device, comprising:
a liquid crystal cell having liquid crystal operating in twisted nematic mode;
a first compensating element disposed either on the light entrance side or on the light exit side of the liquid crystal cell and made of an optical material having positive uniaxial characteristics;
a second compensating element disposed either on the light entrance side or on the light exit side of the liquid crystal cell and made of an optical material having positive uniaxial characteristics;
a third compensating element disposed at least either on the light entrance side or on the light exit side of the liquid crystal cell and made of an optical material which satisfies the following condition for parameters Re and Rth concerning refractive index anisotropy
−Rth<Re<Rth; and
a pair of polarizing elements between which the liquid crystal cell, the first compensating element, the second compensating element, and the third compensating element are disposed.

2. The liquid crystal device according to claim 1, wherein the third compensating element is disposed in such a position that the minimum axis of refractive index ellipsoid extends in the normal line directions of the entrance surface and exit surface of the liquid crystal cell in parallel with each other.

3. The liquid crystal device according to claim 1, wherein the third compensating element is either a sapphire plate or an extended film.

4. The liquid crystal device according to claim 3, wherein the third compensating element has a plurality of extended films.

5. The liquid crystal device according to claim 4, wherein the plural extended films are disposed in such positions that retardation produced within a plane in parallel with the entrance surface and exit surface of the liquid crystal cell can be cancelled.

6. The liquid crystal device according to claim 1, wherein the third compensating element is disposed away from at least either the liquid crystal cell or the pair of the polarizing elements.

7. The liquid crystal device according to claim 1, wherein each of the first and second compensating elements is a crystal plate.

8. The liquid crystal device according to claim 1, wherein:
each of the first arid second compensating elements has a thickness sufficient for effectively canceling a component in cooperation with each other, which component exists within the plane in parallel with the entrance surface and exit surface and is contained in liquid crystal retardation caused by liquid crystal positioned in the vicinity of the en trainee surface and exit surface in the liquid crystal cell; and
the third compensating element has a thickness sufficient for effectively canceling a component existing in the direction perpendicular to the entrance surface and exit surface and included in the liquid crystal retardation and incidental retardation existing in the direction perpendicular to the entrance surface and exit surface and caused by the first and second compensating elements.

9. A projector, comprising:
the liquid crystal device according to claim 1, the liquid crystal device modulating light;
an illumination device which illuminates the liquid crystal device; and
a projection lens which projects an image formed by the liquid crystal device.

10. The projector according to claim 9, wherein the third compensating element is disposed in such a position that the minimum axis of refractive index ellipsoid extends in the normal line directions of the entrance surface and exit surface of the liquid crystal cell in parallel with each other.

11. The projector according to claim 9, wherein the third compensating element is either a sapphire plate or an extended film.

12. The projector according to claim 11, wherein the third compensating element has a plurality of extended films.

13. The projector according to claim 12, wherein the plural extended films are disposed in such positions that retardation produced within a plane in parallel with the entrance surface and exit surface of the liquid crystal cell can be cancelled.

14. The projector according to claim 9, wherein the third compensating element is disposed away from at least either the liquid crystal cell or the pair of the polarizing elements.

15. The projector according to claim 9, wherein each of the first and second compensating elements is a crystal plate.

16. The projector according to claim 9, wherein:
each of the first and second compensating elements has a thickness sufficient for effectively canceling a component in cooperation with each other, which component exists within the plane in parallel with the entrance surface and exit surface and is contained in liquid crystal retardation caused by liquid crystal positioned in the vicinity of the entrance surface and exit surface in the liquid crystal cell; and
the third compensating element has a thickness sufficient for effectively canceling a component existing in the direction perpendicular to the entrance surface and exit surface and included in the liquid crystal retardation and incidental retardation existing in the direction perpendicular to the entrance surface and exit surface and caused by the first and second compensating elements.
